(19) United States
(12) Patent Application Publication
(10) Pub. No.: US 2025/0229682 A1
(43) Pub. Date: Jul. 17, 2025

(54) SEAT SYSTEM FOR A VEHICLE, VEHICLE COMPRISING A SEAT SYSTEM, AND METHOD FOR OPERATING A SEAT SYSTEM

(71) Applicants: Ningbo Geely Automobile Research & Development Co., Ltd., Ningbo (CN); Zhejiang Geely Holding Group Co., Ltd., Zhejiang (CN)

(72) Inventors: Aditya JANGID, Göteborg (SE); Magnus CARLSSON, Ytterby (SE)

(21) Appl. No.: 19/097,661

(22) Filed: Apr. 1, 2025

Related U.S. Application Data
(63) Continuation of application No. PCT/CN2023/124539, filed on Oct. 13, 2023.

(30) Foreign Application Priority Data
Oct. 19, 2022 (EP) 22202539

(51) Int. Cl. B60N 2/68; B60N 2/02; B60N 2/838; B60N 2/90

(52) U.S. Cl. CPC B60N 2/688; B60N 2/02246; B60N 2/838; B60N 2/995; B60N 2002/0216; B60N 2002/022

(57) ABSTRACT

A seat system for a vehicle includes a seat and a frame structure connected to a vehicle structure. The seat is pivotably arranged relative to the frame around a pivot axis and pivots between first and second seating positions. The seat includes first and second seat parts connected to each other. In the first position, the first seat part forms a backrest and the second seat part forms a seat platform. In the second position, the first seat part forms a seat platform and the second seat part forms a backrest. The seat includes an integrated first seatbelt system in connection to the first seat part, where the first seatbelt system is worn by a user in the first position. The vehicle seat includes an integrated second seatbelt system in connection to the second seat part, where the second seatbelt system is worn by a user in the second position.

### RELATED APPLICATION DATA

This application is a continuation of International Patent Application No. PCT/CN2023/124539, filed Oct. 13, 2023, and claims the benefit of European Patent Application No. 22202539.7, filed Oct. 19, 2022, the disclosures of which are incorporated herein by reference in their entireties.

### TECHNICAL FIELD

The present disclosure relates to a seat system for a vehicle comprising a vehicle seat and a frame structure, where the frame structure is connected to a vehicle structure. The vehicle seat is pivotably arranged relative to the frame structure around a pivot axis and configured for pivoting around the pivot axis between a first seating position and a second seating position opposite each other. The disclosure further relates to a vehicle comprising a seat system and a method for operating a seat system for a vehicle.

### BACKGROUND

Vehicle seats that can be arranged in different positions are becoming more and more popular in vehicle applications. A vehicle seat having a pivoting positioning function is enabling flexible vehicle seating solutions.

However, traditional vehicle seat systems with pivoting seat configurations commonly have complex constructions, which may be a drawback when the vehicle seat is exerted to forces in a vehicle impact event. Traditional seatbelt arrangements in connection to the pivoting seat are non-flexible and difficult to adjust when worn by a user of the vehicle for an optimal seatbelt positioning in different vehicle seat pivoting positions. The complex and non-flexible designs are resulting in heavy and costly constructions of the seat systems to achieve desired performance.

There is thus a need for an improved pivoting vehicle seat system having a simple and efficient design that is providing high safety for the user of the vehicle.

### SUMMARY

An object of the present disclosure is to provide a seat system for a vehicle, a vehicle comprising a seat system, and a method for operating a seat system for a vehicle, where the previously mentioned problems are avoided.

The disclosure concerns a seat system for a vehicle comprising a vehicle seat and a frame structure, where the frame structure is connected to a vehicle structure. The vehicle seat is pivotably arranged relative to the frame structure around a pivot axis and configured for pivoting around the pivot axis between a first seating position and a second seating position opposite each other. The vehicle seat comprises a first seat part and a second seat part connected to each other. In the first seating position, the first seat part is forming a backrest and the second seat part is forming a seat platform. In the second seating position, the first seat part is forming a seat platform and the second seat part is forming a backrest. The vehicle seat comprises an integrated first seatbelt system arranged in connection to the first seat part, where the first seatbelt system is configured for being worn by a user of the vehicle in the first seating position. The vehicle seat comprises an integrated second seatbelt system arranged in connection to the second seat part, where the second seatbelt system is configured for being worn by a user of the vehicle in the second seating position.

Advantages with these features are that with the two integrated seatbelt systems, the vehicle seat can be made simple in construction without the need for seatbelt anchoring points in the vehicle structure. The integration of the seatbelt systems within the vehicle seat is enabling an efficient design, where the seatbelt systems are flexible to use and simple to adjust when worn by a user of the vehicle, for an optimal seatbelt positioning in different vehicle seat pivoting positions. The pivoting vehicle seat, where the first seating position and the second seating position are arranged opposite each other, allows a user to change direction of seating position, without compromising with safety. The vehicle seat can be made lightweight in construction and simple to adjust compared to traditional solutions. The vehicle seat system design is enabling high safety for the user of the vehicle.

In one embodiment, the first seat part comprises a first inner end and a first outer end. The first inner end is arranged in connection to the pivot axis. The second seat part comprises a second inner end and a second outer end. The second inner end is arranged in connection to the pivot axis. The respective inner ends are forming sections of the seat parts connected to the pivot axis, enabling the vehicle seat and the seat parts to pivot around the pivot axis for an efficient and simple design of the seat system.

In one embodiment, the first seatbelt system comprises a first seatbelt integrated in the first seat part. The first seatbelt is extending from a first inner attachment point arranged in the first seat part in connection to the first inner end, to a first outer attachment point arranged in connection to an outer side of the first seat part at the first inner end via the first outer end. The second seatbelt system comprises a second seatbelt integrated in the second seat part. The second seatbelt is extending from a second inner attachment point arranged in the second seat part in connection to the second inner end, to a second outer attachment point arranged in connection to an outer side of the second seat part at the second inner end via the second outer end. With these seatbelt system configurations, the seatbelts can be fully integrated in the vehicle seats for a highly flexible seating solution.

In one embodiment, the first seat part comprises a first seatbelt channel extending between the first inner attachment point and the first outer end, where the first seatbelt is extending in the first seatbelt channel. The second seat part comprises a second seatbelt channel extending between the second inner attachment point and the second outer end, where the second seatbelt is extending in the second seatbelt channel. The first and second seatbelt channels are forming channel structures inside the respective seat parts in which the corresponding seatbelts are allowed to run freely when being used.

In one embodiment, the first inner attachment point is arranged as a seatbelt retractor configured for retracting and releasing the first seatbelt, and the second inner attachment point is arranged as a seatbelt retractor configured for retracting and releasing the second seatbelt. The seatbelt retractors are used for a simple and efficient handling of the seatbelts, where the seatbelts can be easily released and retracted when used. With the seatbelt retractors, the first seatbelt can be retracted and released within in the first seatbelt channel from the seatbelt retractor forming the first inner attachment point, and the second seatbelt can be retracted and released within in the second seatbelt channel from the seatbelt retractor forming the second inner attachment point.

In one embodiment, the vehicle seat comprises a seatbelt lock arranged on a lateral side of the vehicle seat in connection to the pivot axis. The seatbelt lock is configured for releasably connecting the first seatbelt in the first seating position and releasably connecting the second seatbelt in the second seating position.

In one embodiment, the seatbelt lock is positioned in connection to the pivot axis and arranged on an opposite lateral side of the vehicle seat relative to the first outer attachment point and the second outer attachment point. The seatbelt lock is with this positioning efficiently used for both the first seatbelt and the second seatbelt in the respective seating positions.

In one embodiment, the vehicle seat comprises a first outer seat section attached to the first outer end of the first seat part. The first outer seat section is pivotably arranged relative to the first seat part, and the first outer seat section is forming a headrest in the first seating position. The vehicle seat comprises a second outer seat section attached to the second outer end of the second seat part. The second outer seat section is pivotably arranged relative to the second seat part, and the second outer seat section is forming a headrest in the second seating position. The outer seat sections are in this way adjustable relative to the corresponding seat parts for an efficient positioning of the adjustable headrest in the respective seating positions.

In one embodiment, each of the first seat part and the second seat part is pivotably arranged relative to the frame structure around the pivot axis. The pivotably arranged seat parts are providing a flexible seating solution allowing different seating positions for the user of the vehicle when seated in the vehicle seat.

In one embodiment, the first seat part is individually adjustable relative to the frame structure and relative to the second seat part. The second seat part is individually adjustable relative to the frame structure and relative to the first seat part. This is enabling an efficient adjustment of the seat parts independently of each other. The first seat part and the second seat part are individually adjustable relative to each other for a flexible seating solution. The seat part functioning as the backrest may be adjustable around the pivot axis relative to the seat part functioning as seat platform and vice versa.

In one embodiment, the seat system further comprises a first main actuator and a second main actuator arranged in the vehicle seat. The first main actuator is configured for enabling the individual adjustment of the first seat part relative to the frame structure around the pivot axis. The second main actuator is configured for enabling the individual adjustment of the second seat part relative to the frame structure around the pivot axis. The main actuators are providing an efficient adjustment of the seat parts relative to the frame structure around the pivot axis.

In one embodiment, the first main actuator is arranged as an electric motor, and the second main actuator is arranged as an electric motor. The electric motors are providing a simple and efficient individual adjustment of the first and second seat parts relative to the frame structure around the pivot axis.

In one embodiment, the first seat part comprises a first inner sub-section and a first outer sub-section pivotably arranged relative to each other, and/or the second seat part comprises a second inner sub-section and a second outer sub-section pivotably arranged relative to each other. This adjustable configuration is enabling individual positioning of the respective first seat parts when forming the backrest or the seat platform in the respective seating positions, for a flexible seating solution allowing different seating positions for the user of the vehicle when seated in the vehicle seat.

In one embodiment, the frame structure is connected to the vehicle structure via a rail structure. The rail structure enables a mechanical sliding connection between the frame structure with the vehicle seat and the vehicle structure. Suitably, the rail structure comprises two interconnected rail parts that are linearly slidable relative to each other, where a lower rail is stationary attached to the vehicle structure and an upper rail is fastened to the frame structure. The upper rail may be movably arranged in relation to the lower rail in a longitudinal direction of the vehicle, for a convenient adjustment and positioning of the vehicle seat in relation to the vehicle structure. Usually, two parallel rail structures are used for holding one vehicle seat.

The disclosure further concerns a vehicle comprising a seat system as described above.

The disclosure further concerns a method for operating a seat system of a vehicle as described above. The method comprises the steps: arranging the vehicle seat in the first seating position for enabling usage of the first seatbelt system, or arranging the vehicle seat in the second seating position for enabling usage of the second seatbelt system.

Advantages with these steps are that with the two integrated seatbelt systems, the vehicle seat can be made simple in construction without the need for seatbelt anchoring points in the vehicle structure. The integration of the seatbelt systems within the vehicle seat is enabling an efficient design, where the seatbelt systems are flexible to use and simple to adjust when worn by a user of the vehicle, for an optimal seatbelt positioning in different vehicle seat pivoting positions. The pivoting vehicle seat, where the first seating position and the second seating position are arranged opposite each other allows a user to change direction of seating position, without compromising with safety.

### BRIEF DESCRIPTION OF THE DRAWINGS

The disclosure will be described in detail in the following, with reference to the attached drawings, in which

FIGS. 1A-1B show schematically, in side views, a vehicle with a seat system having a vehicle seat arranged in a forward position and in a rearward position,

FIGS. 2A-2C show schematically, in side views, the seat system with the vehicle seat arranged in a first seating position, in an intermediate position, and in a second seating position,

FIGS. 3A-3B show schematically, in perspective views, the seat system with the vehicle seat arranged in the first seating position and in the second seating position, and

FIGS. 4A-4B show schematically, in a perspective view and in a side view, an internal configuration of the vehicle seat.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

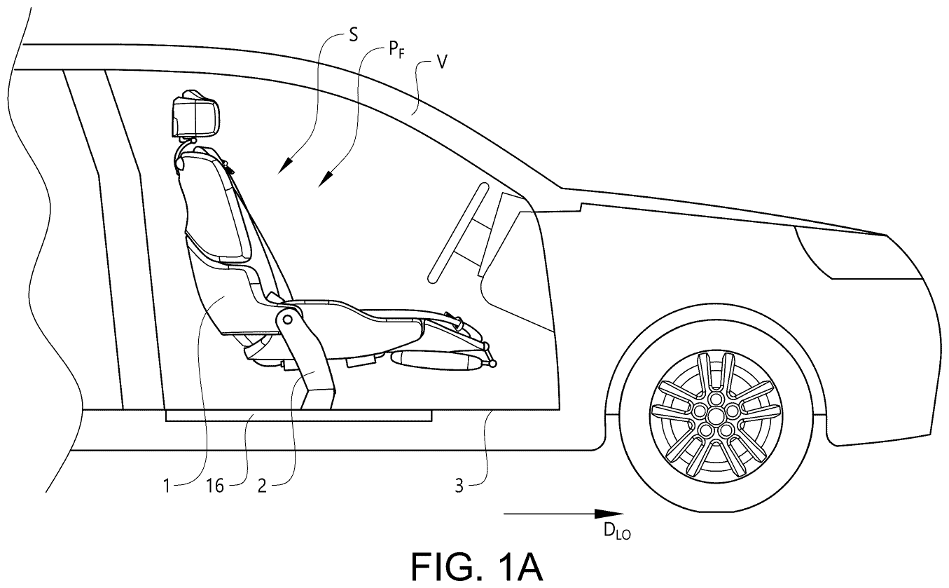

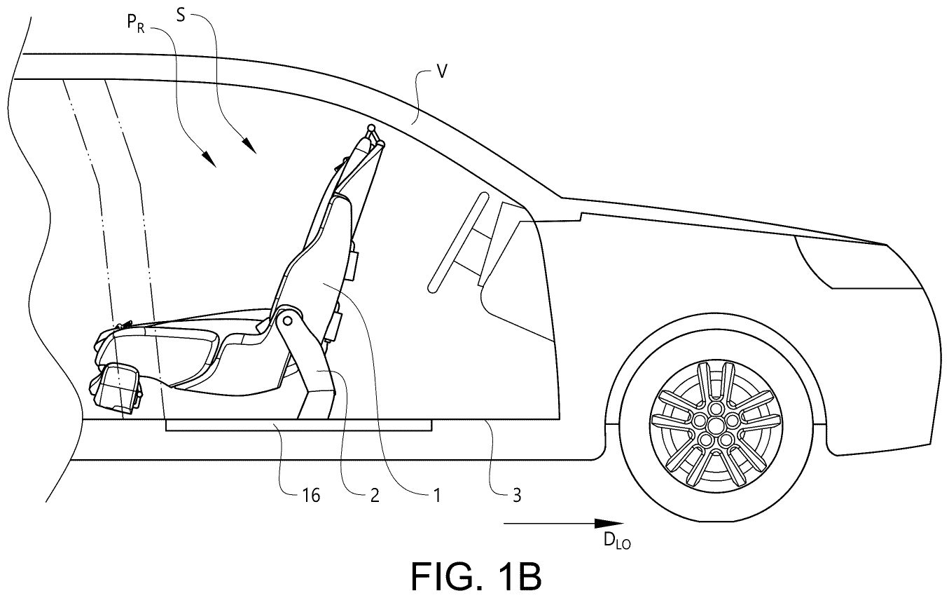

FIGS. 1A-1B schematically shows a vehicle V with a seat system S. The seat system S comprises a vehicle seat 1 attached to a frame structure 2, and the frame structure 2 is connected to a vehicle structure 3. In the shown embodiment, the vehicle structure 3 is a floor structure of an interior compartment of the vehicle V. However, the vehicle structure 3 may be any suitable floor structure or other suitable structural part of the vehicle V, such as a sill structure, a side structure, or a combination of different interior vehicle structures. In FIGS. 1A-1B, the seat system S is illustrated in connection to a front vehicle seat, but the seat system S may be used also for other vehicle seats. In FIG. 1A, the vehicle seat 1 is arranged in a forwards position P_{F}, and in FIG. 1B, the vehicle seat 1 is arranged in a rearwards position P_{R}.

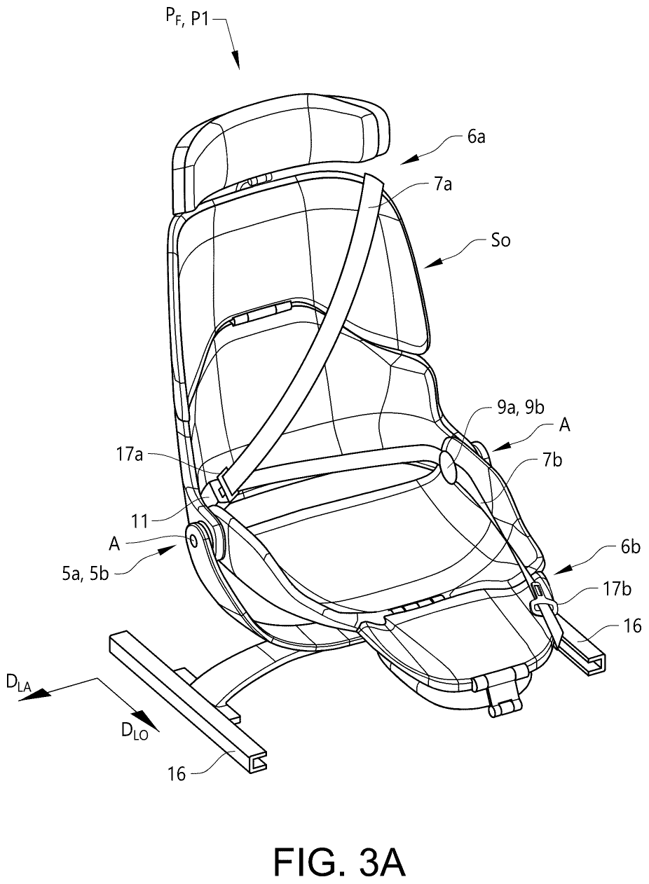

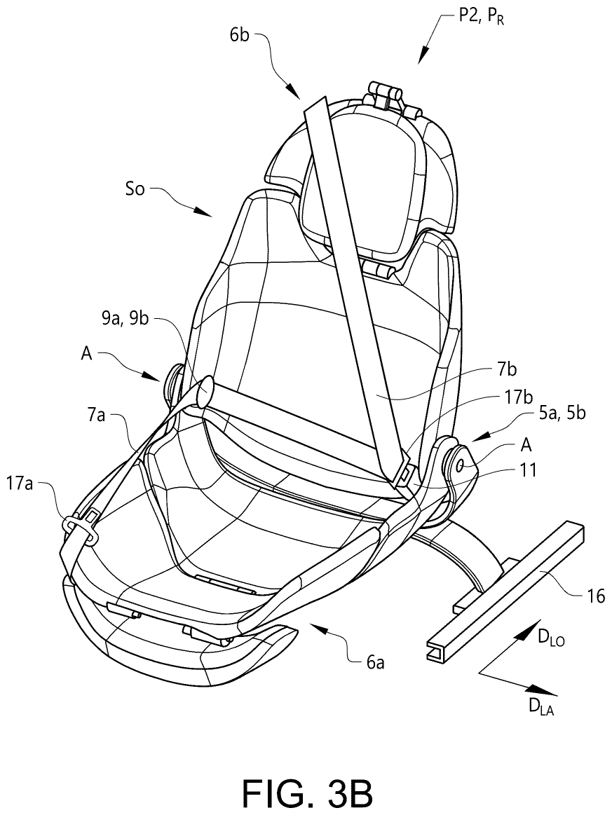

The frame structure 2 is in the illustrated embodiment connected to the vehicle structure 3 via a rail structure 16 as shown in FIGS. 1A-1B, 2A-2C, 3A-3B and 4A-4B. The rail structure 16 enables a mechanical sliding connection between the frame structure 2 with the vehicle seat 1 and the vehicle structure 3. Suitably, the rail structure 16 comprises two interconnected rail parts that are linearly slidable relative to each other, where a lower rail is stationary attached to the vehicle structure 3 and an upper rail is fastened to the frame structure 2. The upper rail may be movably arranged in relation to the lower rail in a longitudinal direction D_{LO} of the vehicle V, for a convenient adjustment and positioning of the vehicle seat 1 in relation to the vehicle structure 3. Usually, two parallel rail structures 16 are used for holding one vehicle seat 1, as shown in for example FIGS. 3A-3B. The frame structure 2 with the vehicle seat 1 may suitably be moved along the rail structures 16 by means of an electric motor or similar actuating device. In other embodiments, the frame structure 2 with the vehicle seat 1 may be manually adjusted along the rail structures 16.

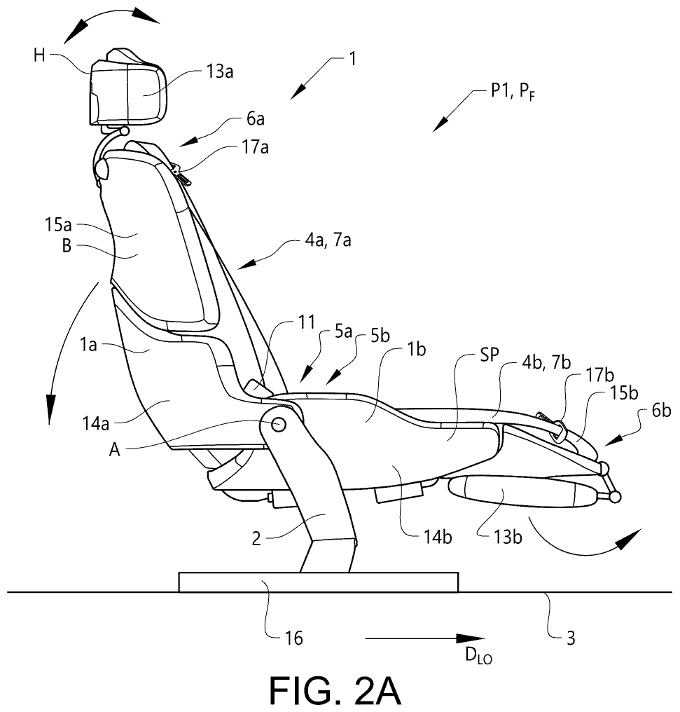

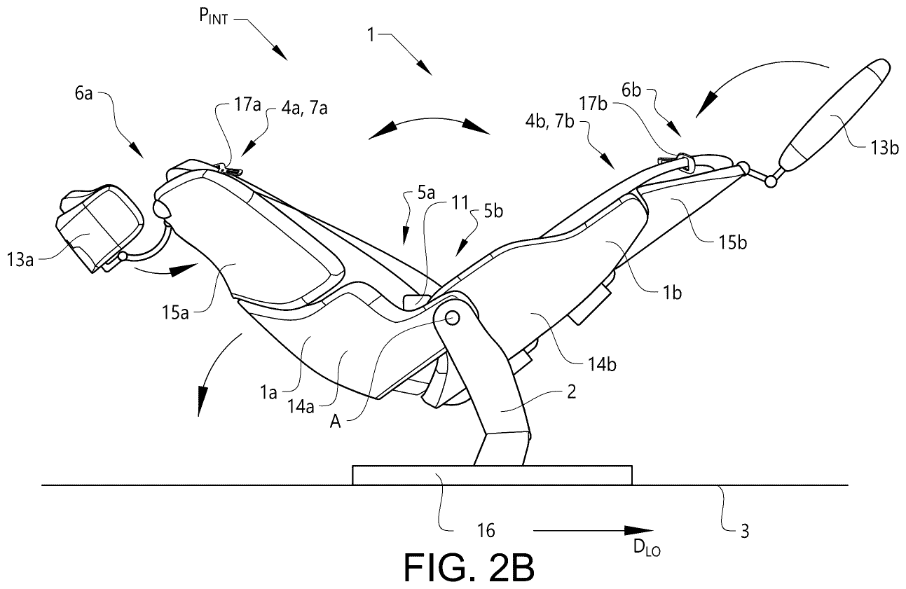

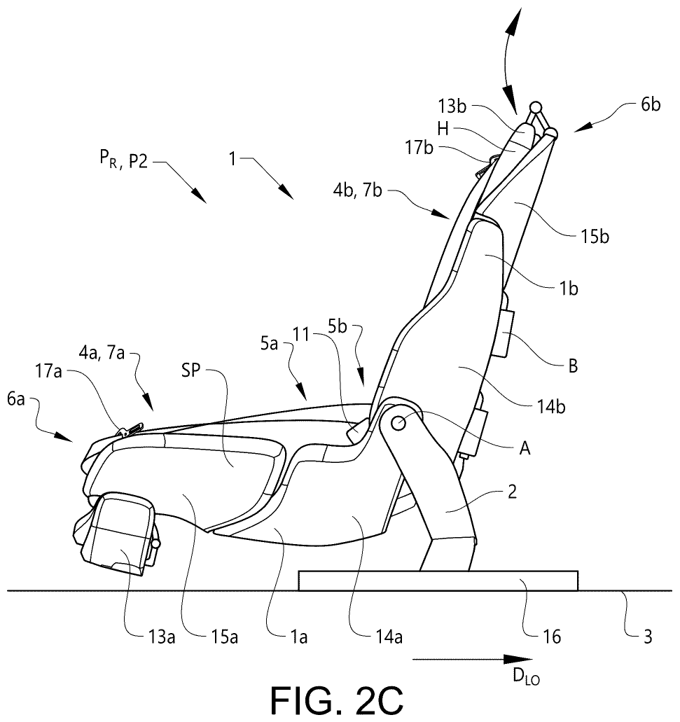

As illustrated in FIGS. 2A-2B, the vehicle seat 1 is pivotably arranged relative to the frame structure 2 around a pivot axis A. The vehicle seat 1 is arranged for pivoting around the pivot axis A between a first seating position P1, as shown in FIGS. 1A and 2A, and a second seating position P2, as shown in FIGS. 1B and 2C. In the illustrated embodiment, the vehicle seat 1 is attached to the frame structure 2 in two pivoting points on each lateral side of the vehicle seat forming the pivot axis A, where lateral is referring to a lateral direction D_{LA} perpendicular to the longitudinal direction D_{LO}. In FIG. 2B, an intermediate position P_{INT} of the vehicle seat 1 between the first seating position P1 and the second seating position P2 is schematically illustrated. The vehicle seat 1 has a shape that allows the vehicle seat 1 to pivot around the pivot axis A without interfering with the frame structure 2.

As understood from the figures, the first seating position P1 and the second seating position P2 are arranged opposite each other. In the illustrated embodiment, the first seating position P1 is corresponding to the forwards position P_{F} and the second seating position is corresponding to the rearwards position P_{R}. The forwards position P_{F} is a position of the vehicle seat 1, in which a user of the vehicle V is seated in a forwards facing position suitable for driving or operating the vehicle. The rearwards position P_{R} is a position of the vehicle seat 1, in which a user of the vehicle V is seated in a rearwards facing position. The rearwards position P_{R} is arranged opposite to the forwards position P_{F}, or essentially opposite the forwards position P_{F}. The vehicle seat 1 may be enabled to adopt any pivoting position around the pivot axis A between the first position P1 and the second position P2.

As shown in for example FIGS. 2A-2C, the vehicle seat 1 comprises a first seat part 1a and a second seat part 1b connected to each other. In the first seating position P1, the first seat part 1a is forming a backrest B and the second seat part 1b is forming a seat platform SP. In the second seating position P2, the first seat part 1a is forming a seat platform SP and the second seat part 1b is forming a backrest B. As described above, the vehicle seat 1 has a shape that allows the vehicle seat 1 to rotate around the pivot axis A without interfering with the frame structure 2, and the seat parts of the vehicle seat 1 forming the backrest B in the first position P1 and second position P2 can pivot without interfering with the frame structure 2.

The first seat part 1a comprises a first inner end 5a and a first outer end 6a, and the first inner end 5a is arranged in connection to the pivot axis A. The second seat part 1b comprises a second inner end 5b and a second outer end 6b, and the second inner end 5b is arranged in connection to the pivot axis A.

Each of the first seat part 1a and the second seat part 1b is in the illustrated embodiment pivotably arranged relative to the frame structure 2 around the pivot axis A. Further, the first seat part 1a is suitably individually adjustable relative to the frame structure 2 and relative to the second seat part 1b. The second seat part 1b is suitably individually adjustable relative to the frame structure 2 and relative to the first seat part 1a.This adjustable configuration is enabling individual positioning of the first seat part 1a and the second seat part 1b relative to each other for a flexible seating solution allowing different seating positions for the user of the vehicle V when seated in the vehicle seat 1, where the seat part functioning as the backrest B may be adjustable around the pivot axis A relative to the seat part functioning as seat platform SP and vice versa.

As shown in for example FIGS. 2A-2C, the vehicle seat 1 further comprises a first outer seat section 13a attached to the first outer end 6a of the first seat part 1a. The first outer seat section 13a is pivotably arranged relative to the first seat part 1a, as indicated with the arrow in FIG. 2A. The first outer section 13a and the first outer end 6a of the first seat part 1a are suitably connected to each other via a pivoting joint, enabling adjustment of the first outer seat section 13a in different positions. The first outer seat section 13a is in this way forming an adjustable headrest H in the first seating position P1. The first outer section 13a may be manually adjustable relative to the first seat part 1a, or alternatively the first outer section 13a may be adjustable relative to the first seat part 1a via suitable actuator means enabling an efficient positioning of the adjustable headrest H in the first seating position P1. The actuator may be arranged as an electric motor or a linear actuator integrated in the first seat part 1a or in the first outer section 13a.

As shown in for example FIGS. 2A-2C, the vehicle seat 1 further comprises a second outer seat section 13b attached to the second outer end 6b of the second seat part 1b. The second outer seat section 13b is pivotably arranged relative to the second seat part 1b as indicated with the arrow in FIG. 2C. The second outer section 13b and the second outer end 6b of the second seat part 1b are suitably connected to each other via a pivoting joint, enabling adjustment of the second outer seat section 13b in different positions. The second outer seat section 13b is in this way forming an adjustable headrest H in the second seating position P2. The second outer section 13b may be manually adjustable relative to the second seat part 1b, or alternatively the second outer section 13b may be adjustable relative to the second seat part 1b via suitable actuator means enabling an efficient positioning of the adjustable headrest H in the second seating position P2. The actuator may be arranged as an electric motor or a linear actuator integrated in the second seat part 1b or in the second outer section 13b.

As shown in for example FIGS. 2A-2C, the first seat part 1a comprises a first inner sub-section 14a and a first outer sub-section 15a pivotably arranged relative to each other. In this way, the first inner sub-section 14a and the first outer sub-section 15a are individually adjustable relative to each other. This adjustable configuration is enabling individual positioning of the first seat part 1a, when forming the backrest B or the seat platform SP in the respective seating positions, for a flexible seating solution allowing different seating positions for the user of the vehicle V when seated in the vehicle seat 1. The first inner sub-section 14a and the first outer sub-section 15a are suitably connected to each other via a pivoting joint for manual adjustment, or electrical adjustment via suitable actuator means enabling an efficient positioning of the sub-sections relative to each other.

As shown in for example FIGS. 2A-2C, the second seat part 1b comprises a second inner sub-section 14b and a second outer sub-section 15b pivotably arranged relative to each other. In this way, the second inner sub-section 14b and the second outer sub-section 15b are individually adjustable relative to each other. This adjustable configuration is enabling individual positioning of the second seat part 1b, when forming the backrest B or the seat platform SP in the respective seating positions, for a flexible seating solution allowing different seating positions for the user of the vehicle V when seated in the vehicle seat 1. The second inner sub-section 14b and the second outer sub-section 15b are suitably connected to each other via a pivoting joint for manual adjustment, or electrical adjustment via suitable actuator means enabling an efficient positioning of the sub-sections relative to each other.

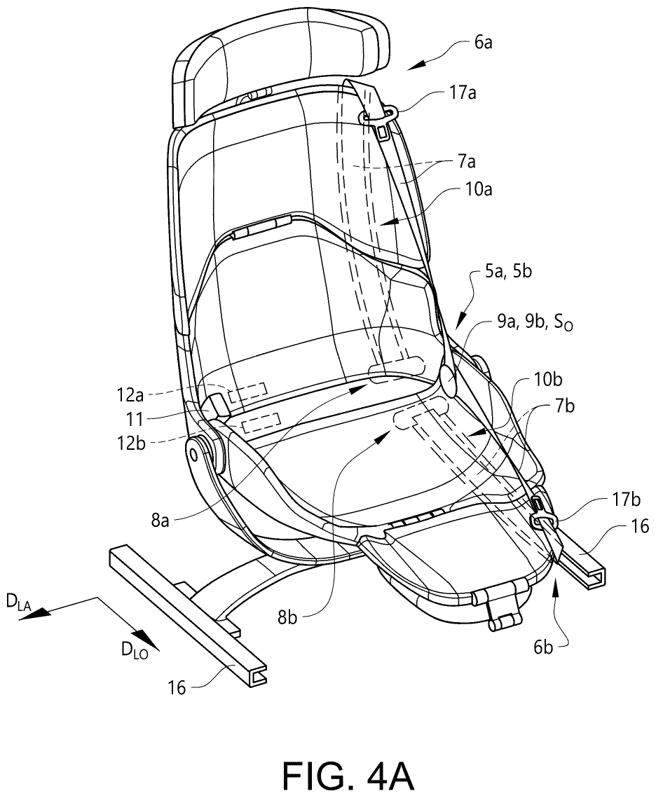

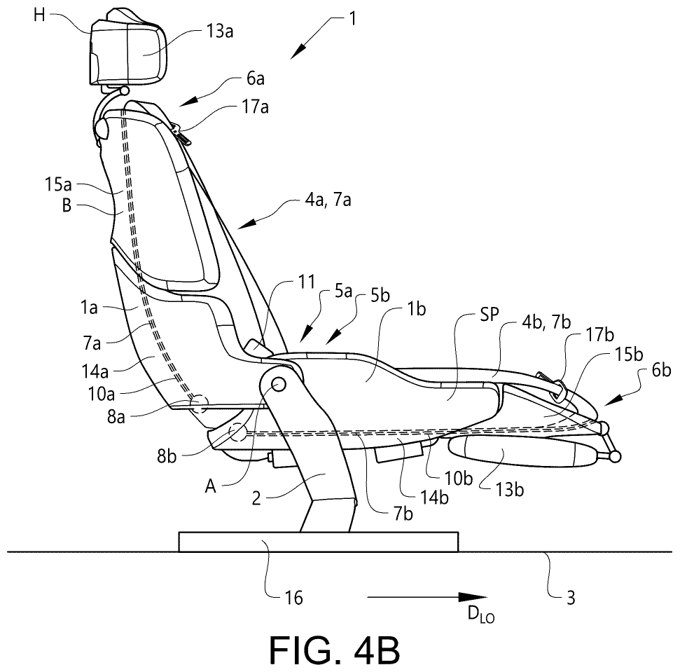

The seat system S further comprises a first main actuator 12a and a second main actuator 12b arranged in the vehicle seat 1. The first main actuator 12a is configured for enabling the individual adjustment of the first seat part 1a relative to the frame structure 2 around the pivot axis A. The second main actuator 12b is configured for enabling the individual adjustment of the second seat part 1b relative to the frame structure 2 around the pivot axis A. Suitably, the first main actuator 12a and the second main actuator 12b are arranged as electric motors integrated in the vehicle seat 1, where the first main actuator 12a is integrated in the first seat part 1a and the second main actuator is integrated in the second seat part 1b, as schematically indicated in FIG. 4A.

The vehicle seat 1 is suitably connected to a control unit for controlling the positioning of the vehicle seat 1.

The vehicle seat 1 comprises an integrated first seatbelt system 4a arranged in connection to the first seat part 1a,as shown in for example FIGS. 2A-2C, 3A-3B and 4A-4B, and the first seatbelt system 4a is configured for being worn by a user of the vehicle V in the first seating position P1.

The first seatbelt system 4a comprises a first seatbelt 7a integrated in the first seat part 1a. The first seatbelt 7a is extending from a first inner attachment point 8a arranged in the first seat part 1a in connection to the first inner end 5a to a first outer attachment point 9a via the first outer end 6a. As shown in FIG. 4A, the first inner attachment point 8a is arranged within the first seat part 1a, and the first inner attachment point 8a is establishing a firm connection between the first seatbelt 7a and the first seat part 1a for a secure inner anchoring of the first seatbelt 7a to the vehicle seat 1. The first inner attachment point 8a is suitably arranged as a seatbelt retractor, enabling a rolled-up configuration of the inner part of the first seatbelt 7a for retracting and releasing the first seatbelt 7a. The first outer attachment point 9a is arranged in connection to an outer side S_{O} of the first seat part 1a at the first inner end 5a. The first outer attachment point 9a is establishing a firm connection between the first seatbelt 7a and the first seat part 1a for a secure outer anchoring of the first seatbelt 7a to the vehicle seat 1.

The first seat part 1a comprises a first seatbelt channel 10a extending between the first inner attachment point 8a and the first outer end 6a, and the first seatbelt 7a is extending in the first seatbelt channel 10a, as shown in FIGS. 4A-4B. The first seatbelt channel 10a is forming a channel structure inside the first seat part 1a in which the first seatbelt 7a is allowed to run freely when retracted into the seatbelt retractor or released from the seatbelt retractor. In this way, the first seatbelt 7a can be retracted and released within in the first seatbelt channel 10a from the seatbelt retractor forming the first inner attachment point 8a.

The vehicle seat 1 comprises an integrated second seatbelt system 4b arranged in connection to the second seat part 1b, as shown in for example FIGS. 2A-2C, 3A-3B and 4A-4B, and the second seatbelt system 4b is configured for being worn by a user of the vehicle V in the second seating position P2.

The second seatbelt system 4b comprises a second seatbelt 7b integrated in the second seat part 1b. The second seatbelt 7b is extending from a second inner attachment point 8b arranged in the second seat part 1b in connection to the second inner end 5b to a second outer attachment point 9b via the second outer end 6b. As shown in FIG. 4A, the second inner attachment point 8b is arranged within the second seat part 1b, and the second inner attachment point 8b is establishing a firm connection between the second seatbelt 7b and the second seat part 1b for a secure inner anchoring of the second seatbelt 7b to the vehicle seat 1. The second inner attachment point 8b is suitably arranged as a seatbelt retractor, enabling a rolled-up configuration of the inner part of the second seatbelt 7b for retracting and releasing the second seatbelt 7b. The second outer attachment point 9b is arranged in connection to an outer side S_{O} of the second seat part 1b at the second inner end 5b. The second outer attachment point 9b is establishing a firm connection between the second seatbelt 7b and the second seat part 1b for a secure outer anchoring of the second seatbelt 7b to the vehicle seat 1.

The second seat part 1b comprises a second seatbelt channel 10b extending between the second inner attachment point 8b and the second outer end 6b, and the second seatbelt 7b is extending in the second seatbelt channel 10b, as shown in FIGS. 4A-4B. The second seatbelt channel 10b is forming a channel structure inside the second seat part 1b in which the second seatbelt 7b is allowed to run freely when retracted into the seatbelt retractor or released from the seatbelt retractor. In this way, the second seatbelt 7b can be retracted and released within in the second seatbelt channel 10b from the seatbelt retractor forming the second inner attachment point 8b.

In the illustrated embodiment, the first outer attachment point 9a and the second outer attachment point 9b are arranged as a common anchoring point for the first seatbelt 7a and the second seatbelt 7b. It should however be understood that in other non-illustrated embodiments, the first outer attachment point 9a and the second outer attachment point 9b may be arranged separated from each other.

As shown in the figures, the vehicle seat 1 comprises a seatbelt lock 11 arranged on a lateral side of the vehicle seat 1 in connection to the pivot axis A. As understood from for example FIGS. 3A-3B, the seatbelt lock 11 is used for connecting both the first seatbelt 7a and the second seatbelt 7b, and the seatbelt lock 11 is arranged on an opposite lateral side from the first outer attachment point 9a and the second outer attachment point 9b. The seatbelt lock 11 is configured for releasably connecting the first seatbelt 7a in the first seating position P1 and releasably connecting the second seatbelt 7b in the second seating position P2. The seatbelt lock 11 is positioned in connection to the pivot axis A and arranged on an opposite lateral side of the vehicle seat 1 relative to the first outer attachment point 9a and the second outer attachment point 9b, for a convenient attachment of the first seatbelt 7a or the second seatbelt 7b respectively.

A first seatbelt lock tongue 17a is arranged on the first seatbelt 7a, and the first seatbelt lock tongue 17a is configured for being releasably connected to the seatbelt lock 11 in the first seating position P1, as illustrated in FIG. 3A. In this way, the first seatbelt 7a is configured for being releasably connected to the seatbelt lock 11 via the first seatbelt lock tongue 17a in the first seating position P1. The first seatbelt lock tongue 17a is allowed to slide along the first seatbelt 7a in a conventional manner.

A second seatbelt lock tongue 17b is arranged on the second seatbelt 7b, and the second seatbelt lock tongue 17b is configured for being releasably connected to the seatbelt lock 11 in the second seating position P2, as illustrated in FIG. 3B. In this way, the second seatbelt 7b is configured for being releasably connected to the seatbelt lock 11 via the second seatbelt lock tongue 17b in the second seating position P2. The second seatbelt lock tongue 17b is allowed to slide along the second seatbelt 7b in a conventional manner.

When the vehicle seat 1 is arranged in the first seating position P1, usage of the first seatbelt system 4a is enabled due to the position of the vehicle seat 1. When a user of the vehicle V is seated in the vehicle seat 1 in the first seating position P1, the first seatbelt 7a can be secured across the chest and hips of the user. The first seatbelt 7a is arranged in a traditional way across the user with a section of the first seatbelt 7a extending across the hips and another section extending across the chest, as understood from the position of the first seatbelt 7a shown in FIG. 3A. When the first seatbelt 7a is released from the seatbelt retractor forming the first inner attachment point 8a, it may be extended from the first seatbelt channel 10a and arranged across the body of the user. The user may thereafter simply lock the first seatbelt lock tongue 17a to the seatbelt lock 11 for a secure attachment of the first seatbelt 7a. To unlock the first seatbelt 7a, the user is disconnecting the first seatbelt lock tongue 17a from the seatbelt lock 11, and the first seatbelt 7a may then be partly retracted into the seatbelt retractor via the first seatbelt channel 10a into the position shown in FIGS. 2A and 4A.

When the vehicle seat 1 is arranged in the second seating position P2, usage of the second seatbelt system 4b is enabled due to the position of the vehicle seat 1. When a user of the vehicle V is seated in the vehicle seat 1 in the second seating position P2, the second seatbelt 7b can be secured across the chest and hips of the user. The second seatbelt 7b is arranged in a traditional way across the user with a section of the second seatbelt 7b extending across the hips and another section extending across the chest, as understood from the position of the second seatbelt 7b shown in FIG. 3B. When the second seatbelt 7b is released from the seatbelt retractor forming the second inner attachment point 8b, it may be extended from the second seatbelt channel 10b and arranged across the body of the user. The user may thereafter simply lock the second seatbelt lock tongue 17b to the seatbelt lock 11 for a secure attachment of the second seatbelt 7b. To unlock the second seatbelt 7b, the user is disconnecting the second seatbelt lock tongue 17b from the seatbelt lock 11, and the second seatbelt 7b may then be partly retracted into the seatbelt retractor via the second seatbelt channel 10b into the position indicated in FIG. 2C.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure or as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Vehicle seat
1a: First seat part
1b: Second seat part
2: Frame structure
3: Vehicle structure
4a: First seatbelt system
4b: Second seatbelt system
5a: First inner end
5b: Second inner end
6a: First outer end
6b: Second outer end
7a: First seatbelt
7b: Second seatbelt
8a: First inner attachment point
8b: Second inner attachment point
9a: First outer attachment point
9b: Second outer attachment point
10a: First seatbelt channel
10b: Second seatbelt channel
11: Seatbelt lock
12a: First main actuator
12b: Second main actuator
13a: First outer seat section
13b: Second outer seat section
14a: First inner sub-section
14b: Second inner sub-section
15a: First outer sub-section
15b: Second outer sub-section
16: Rail structure
17a: First seatbelt lock tongue
17b: Second seatbelt lock tongue
A: Pivot axis
B: Backrest
D_{LA}: Lateral direction
D_{LO}: Longitudinal direction
H: Headrest
P1: First seating position
P2: Second seating position
P_{F}: Forwards position
P_{INT}: Intermediate position
P_{R}: Rearwards position
S: Seat system
S_{O}: Outer side
SP: Scat platform
V: Vehicle

What is claimed is:

1. A seat system for a vehicle comprising a vehicle seat and a frame structure, wherein the frame structure is connected to a vehicle structure, wherein the vehicle seat is pivotably arranged relative to the frame structure around a pivot axis and configured for pivoting around the pivot axis between a first seating position and a second seating position opposite each other,
wherein the vehicle seat comprises a first seat part and a second seat part connected to each other, wherein in the first seating position the first seat part is forming a backrest and the second seat part is forming a seat platform, and wherein in the second seating position, the first seat part is forming a seat platform and the second seat part is forming a backrest,
wherein the vehicle seat comprises an integrated first seatbelt system arranged in connection to the first seat part, wherein the first seatbelt system is configured for being worn by a user of the vehicle in the first seating position,
wherein the vehicle seat comprises an integrated second seatbelt system arranged in connection to the second seat part, wherein the second seatbelt system is configured for being worn by a user of the vehicle in the second seating position.

2. The seat system according to claim 1, wherein the first seat part comprises a first inner end and a first outer end, wherein the first inner end is arranged in connection to the pivot axis, wherein the second seat part comprises a second inner end and a second outer end, wherein the second inner end is arranged in connection to the pivot axis.

3. The seat system according to claim 2, wherein the first seatbelt system comprises a first seatbelt integrated in the first seat part, wherein the first seatbelt is extending from a first inner attachment point arranged in the first seat part in connection to the first inner end to a first outer attachment point arranged in connection to an outer side of the first seat part at the first inner end via the first outer end;
wherein the second seatbelt system comprises a second seatbelt integrated in the second seat part, wherein the second seatbelt is extending from a second inner attachment point arranged in the second seat part in connection to the second inner end to a second outer attachment point arranged in connection to an outer side of the second seat part at the second inner end via the second outer end.

4. The seat system according to claim 3, wherein the first seat part comprises a first seatbelt channel extending between the first inner attachment point and the first outer end, wherein the first seatbelt is extending in the first seatbelt channel,
wherein the second seat part comprises a second seatbelt channel extending between the second inner attachment point and the second outer end, wherein the second seatbelt is extending in the second seatbelt channel.

5. The seat system according to claim 4, wherein the first inner attachment point is arranged as a seatbelt retractor configured for retracting and releasing the first seatbelt, and wherein the second inner attachment point is arranged as a seatbelt retractor configured for retracting and releasing the second seatbelt.

6. The seat system according to claim 3, wherein the vehicle seat comprises a seatbelt lock arranged on a lateral side of the vehicle seat in connection to the pivot axis, wherein the seatbelt lock is configured for releasably connecting the first seatbelt in the first seating position and releasably connecting the second seatbelt in the second seating position.

7. The seat system according to claim 6, wherein the seatbelt lock is positioned in connection to the pivot axis and arranged on an opposite lateral side of the vehicle seat relative to the first outer attachment point and the second outer attachment point.

8. The seat system according to claim 2, wherein the vehicle seat comprises a first outer seat section attached to the first outer end of the first seat part, wherein the first outer seat section is pivotably arranged relative to the first seat part and is forming a headrest in the first seating position, and wherein the vehicle seat comprises a second outer seat section attached to the second outer end of the second seat part, wherein the second outer seat section is pivotably arranged relative to the second seat part and is forming a headrest in the second seating position.

9. The seat system according to claim 1, wherein each of the first seat part and the second seat part is pivotably arranged relative to the frame structure around the pivot axis.

10. The seat system according to claim 1, wherein the first seat part is individually adjustable relative to the frame structure and relative to the second seat part, wherein the second seat part is individually adjustable relative to the frame structure and relative to the first seat part.

11. The seat system according to claim 10, wherein the seat system further comprises a first main actuator and a second main actuator arranged in the vehicle seat, wherein the first main actuator is configured for enabling the individual adjustment of the first seat part relative to the frame structure around the pivot axis, wherein the second main actuator is configured for enabling the individual adjustment of the second seat part relative to the frame structure around the pivot axis.

12. The seat system according to claim 11, wherein the first main actuator is arranged as an electric motor, and the second main actuator is arranged as an electric motor.

13. The seat system according to claim 1, wherein the first seat part comprises a first inner sub-section and a first outer sub-section pivotably arranged relative to each other, and/or wherein the second seat part comprises a second inner sub-section and a second outer sub-section pivotably arranged relative to each other.

14. The seat system according to claim 1, wherein the frame structure is connected to the vehicle structure via a rail structure.

15. A vehicle comprising the seat system according to claim 1.

16. A method for operating the seat system of a vehicle according to claim 1, wherein the method comprises:
arranging the vehicle seat in the first seating position for enabling usage of the first seatbelt system, or arranging the vehicle seat in the second seating position for enabling usage of the second seatbelt system.
